(19) United States
(12) Patent Application Publication
(10) Pub. No.: US 2026/0230915 A1
(43) Pub. Date: Aug. 6, 2026

(54) METHOD AND APPARATUS FOR ADAPTIVE BITRATE CONTROL IN WIRELESS COMMUNICATION SYSTEM

(71) Applicant: SETLAB Co., LTD., Gyeonggi-do (KR)

(72) Inventor: Soenghun KIM, Gyeonggi-do (KR)

(21) Appl. No.: 19/530,340

(22) Filed: Feb. 5, 2026

(30) Foreign Application Priority Data
Feb. 6, 2025 (KR) 10-2025-0015483
Jan. 20, 2026 (KR) 10-2026-0011443

(51) Int. Cl. H04W 28/02; H04W 76/20; H04W 80/02

(52) U.S. Cl. CPC H04W 28/0268; H04W 76/20; H04W 80/02

(57) ABSTRACT

A method performed by a terminal for bit rate query in a wireless communication system is provided. The method includes determining a necessity for a bit rate query, and upon availability of an uplink resource for a new transmission, determining whether to generate a Medium Access Control Control Element (MAC CE) for the bit rate query based on whether a predetermined prohibit timer is running and a result of a Logical Channel Prioritization procedure. The method further includes generating and transmitting the MAC CE for the bit rate query. The prohibit timer is configured for either a logical channel or a Quality of Service (QoS) flow depending on the target of the bit rate query. The MAC CE comprises identification information corresponding to the target of the query, and includes n-bit bit rate information for a logical channel query or m-bit bit rate information for a QoS flow query.

### CROSS-REFERENCE TO RELATED APPLICATION

This application claims priority to and the benefit of Korean Patent Application Nos. 10-2025-0015483, filed on Feb. 6, 2025, and 10-2026-0011443, filed on Jan. 20, 2026. Each of the above documents is incorporated herein by reference in its entirety.

### BACKGROUND

### Technical Field

The present invention relates to a wireless communication system, and more particularly, to a Radio Access Network (RAN)-based adaptive bitrate control method and apparatus for multimedia (MM) traffic and Extended Reality (XR) traffic.

### Related Art

Recently, in 5G and Beyond 5G wireless communication systems, the demand for XR services including Virtual Reality (VR), Augmented Reality (AR), and Mixed Reality (MR) has been rapidly increasing. XR services require high-resolution video, low latency, and high data transmission rates to provide users with immersive experiences.

XR services have the following characteristics compared to conventional multimedia services. First, XR traffic requires very high data rates (e.g., 30-100 Mbps). Second, XR applications must maintain Motion-to-Photon latency below 20 ms to prevent users from experiencing motion sickness. Third, XR traffic exhibits significant temporal variations in transmission rate depending on the characteristics of video frames.

Due to these characteristics of XR services, it is essential to adjust the transmission bitrate in real-time according to changes in wireless channel conditions. When the wireless channel is good, high-quality content should be transmitted at a high bitrate, and when the channel condition is poor, the bitrate should be reduced to ensure service continuity.

### SUMMARY

The present invention provides a method and apparatus for efficient bitrate control in a wireless communication system supporting XR services by using a Combined Identifier (CID) that simultaneously identifies a PDU session and a QoS flow for precise bitrate control. The invention employs different granularities of bitrate indices in coarse-grained rate control with 6-bit indices having approximately 13% step size and fine-grained rate control with 7-bit indices having approximately 10% step size to flexibly accommodate diverse service requirements. The CID can be explicitly configured through RRC signaling or automatically derived from PDU session ID and QFI according to a predetermined rule, enabling efficient identification without excessive signaling overhead. Detailed UE and gNB operational procedures are provided for determining which rate control mechanism to apply based on traffic characteristics and channel conditions, and for performing the corresponding rate control operations. The enhanced rate control mechanism improves overall system efficiency and user experience, particularly for demanding XR services, by enabling smooth and responsive bitrate adaptation while reducing signaling overhead.

### BRIEF DESCRIPTION OF THE DRAWINGS

FIG. 1 is a diagram illustrating the architecture of an 5G system and a NG-RAN;

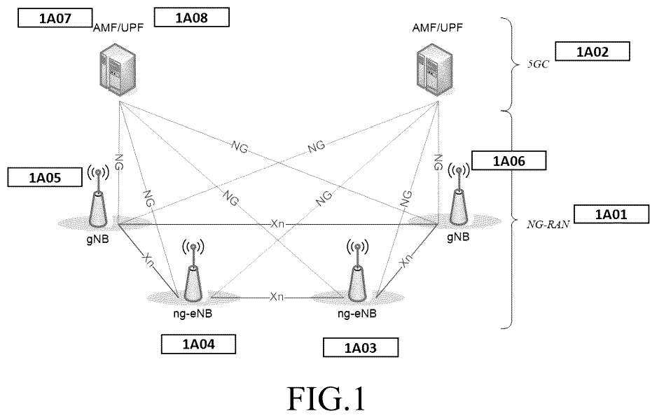

FIG. 2 is a diagram illustrating a wireless protocol architecture in an 5G system;

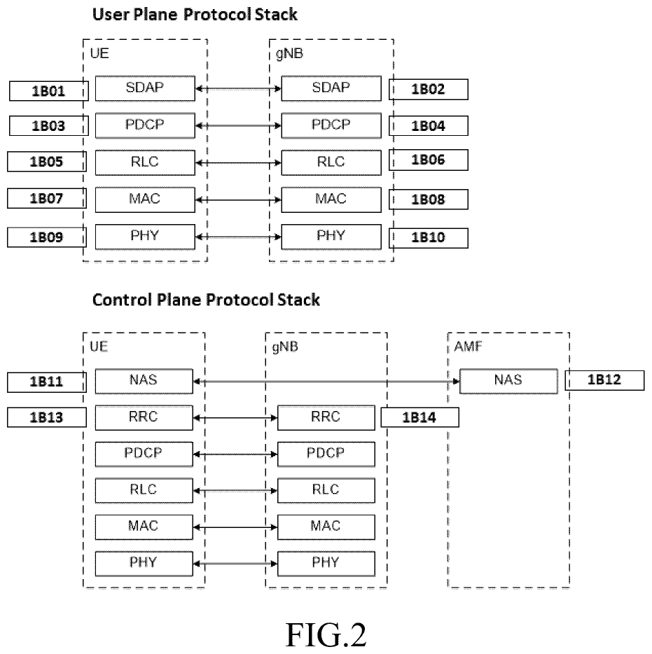

FIG. 3 illustrates overall operation of the UE and network.

FIG. 4 illustrates the operation of the UE regarding PLMN selection and cell selection and cell reselection.

FIG. 5 illustrates RRC connection establishment procedure.

FIG. 6 illustrates UE capability transfer procedure.

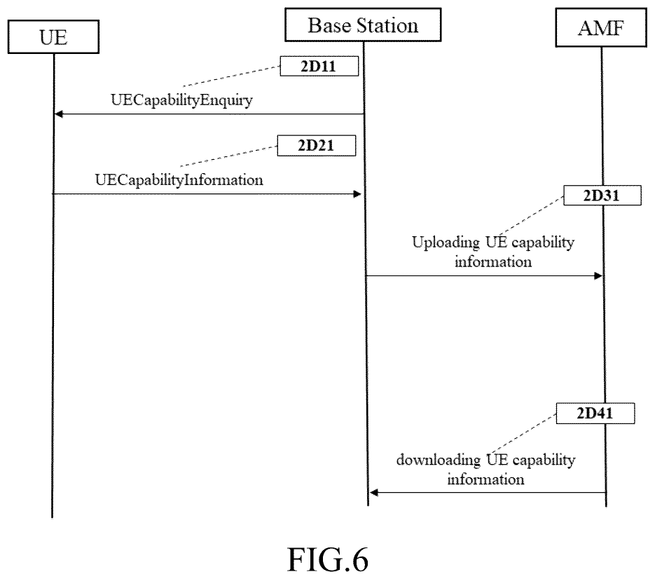

FIG. 7 illustrates RRC connection reconfiguration procedure.

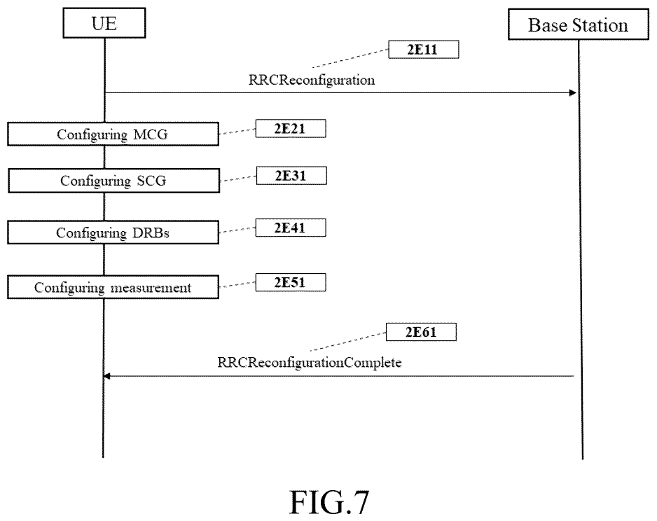

FIG. 8 illustrates data transfer procedure in RRC_CONNECTED state.

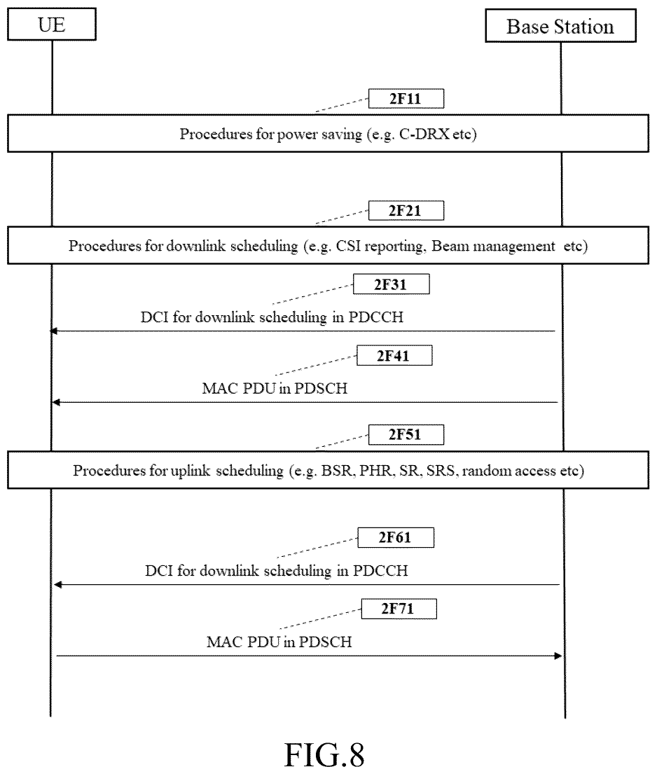

FIG. 9 illustrates bit rate MAC CEs.

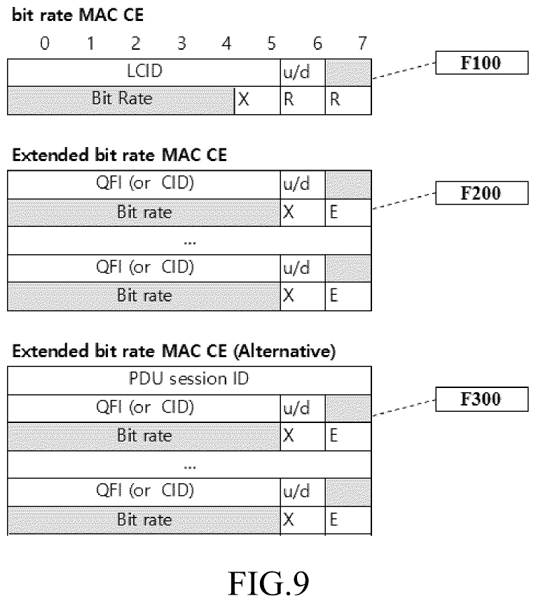

FIG. 10 illustrates operations of the UE and the base station.

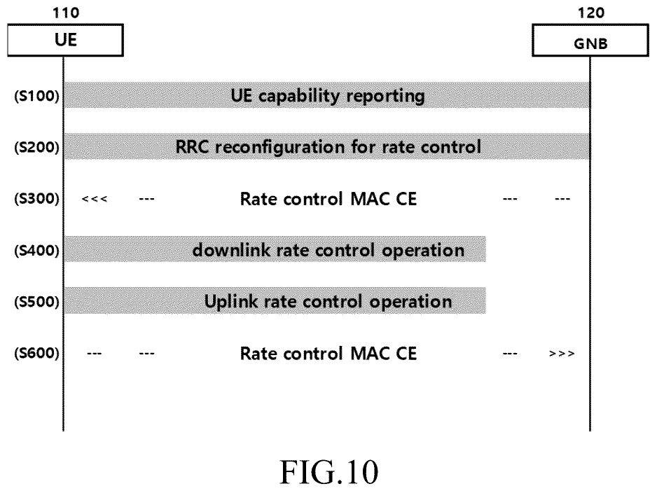

FIG. 11 is a diagram illustrating operations of the base station for rate control.

FIG. 12 is a diagram illustrating operations of the UE for downlink rate control.

FIG. 13 is a diagram illustrating operations of the UE for uplink rate control.

FIG. 14 is a block diagram illustrating the internal structure of a UE to which the disclosure is applied.

FIG. 15 is a block diagram illustrating the configuration of a base station according to the disclosure.

### DETAILED DESCRIPTION

In the rapidly evolving landscape of wireless communication, Extended Reality (XR) applications, encompassing Augmented Reality (AR), Virtual Reality (VR), and Mixed Reality (MR), demand superior data handling capabilities to deliver seamless user experiences. The Buffer Status Reporting (BSR) mechanism in the MAC layer plays a pivotal role in ensuring efficient data transmission by reporting the status of buffers at the user equipment (UE) to the network. However, the traditional BSR mechanisms face challenges in meeting the low latency requirements critical for XR applications.

The present disclosure focuses on mitigating latency issues and ensuring robust connectivity, thereby enabling a seamless and responsive XR experience based on a new mechanism to report delay sensitive data to the base station. This solution aims to enhance data throughput, reduce latency, and improve overall network performance, thereby providing a more immersive and responsive XR experience.

Hereinafter, embodiments of the present disclosure will be described in detail with reference to the accompanying drawings. In addition, in the description of the present disclosure, if it is determined that a detailed description of a related known function or configuration may unnecessarily obscure the gist of the present disclosure, the detailed description thereof will be omitted. In addition, the terms to be described later are terms defined in consideration of functions in the present disclosure, which may vary according to intentions or customs of users and operators. Therefore, the definition should be made based on the content throughout this specification.

The terms used, in the following description, for indicating access nodes, network entities, messages, interfaces between network entities, and diverse identity information is provided for convenience of explanation. Accordingly, the terms used in the following description are not limited to specific meanings but may be replaced by other terms equivalent in technical meanings.

In the following descriptions, the terms and definitions given in the 3GPP standards are used for convenience of explanation. However, the present disclosure is not limited by use of these terms and definitions and other arbitrary terms and definitions may be employed instead.

In the present disclosure, “trigger” or “triggered” and “initiate” or “initiated” can be used interchangeably.

In the present disclosure, UE and terminal and wireless device can be used interchangeably. In the present disclosure, NG-RAN node and base station and GNB can be used interchangeably.

5G system consists of NG-RAN 1A01 and 5GC 1A02. An NG-RAN node is either:
>1: a gNB, providing NR user plane and control plane protocol terminations towards the UE; or
>1: an ng-eNB, providing E-UTRA user plane and control plane protocol terminations towards the UE.

The gNBs 1A05 or 1A06 and ng-eNBs 1A03 or 1A04 are interconnected with each other by means of the Xn interface. The gNBs and ng-eNBs are also connected by means of the NG interfaces to the 5GC, more specifically to the AMF (Access and Mobility Management Function) and to the UPF (User Plane Function). AMF 1A07 and UPF 1A08 may be realized as a physical node or as separate physical nodes.

A gNB 1A05 or 1A06 or an ng-eNBs 1A03 or 1A04 hosts the various functions listed below.
>1: Functions for Radio Resource Management such as Radio Bearer Control, Radio Admission Control, Connection Mobility Control, Dynamic allocation of resources to UEs in uplink, downlink and sidelink (scheduling); and
>1: IP and Ethernet header compression, uplink data decompression and encryption of user data stream; and
>1: Selection of an AMF at UE attachment when no routing to an MME can be determined from the information provided by the UE; and
>1: Routing of User Plane data towards UPF; and
>1: Scheduling and transmission of paging messages; and
>1: Scheduling and transmission of broadcast information (originated from the AMF or O&M); and
>1: Measurement and measurement reporting configuration for mobility and scheduling; and
>1: Session Management; and
>1: QoS Flow management and mapping to data radio bearers; and
>1: Support of UEs in RRC_INACTIVE state; and

The AMF 1A07 hosts the functions such as NAS signaling, NAS signaling security, AS security control, SMF selection, Authentication, Mobility management and positioning management.

The UPF 1A08 hosts the functions such as packet routing and forwarding, transport level packet marking in the uplink, QoS handling and the downlink, mobility anchoring for mobility etc.

User plane protocol stack consists of SDAP 1B01 or 1B02, PDCP 1B03 or 1B04, RLC 1B05 or 1B06, MAC 1B07 or 1B08 and PHY 1B09 or 1B10. Control plane protocol stack consists of NAS 1B11 or 1B12, RRC 1B13 or 1B14, PDCP, RLC, MAC and PHY.

Each protocol sublayer performs functions related to the operations listed below.

NAS: authentication, mobility management, security control etc.

RRC: System Information, Paging, Establishment, maintenance and release of an RRC connection, Security functions, Establishment, configuration, maintenance and release of Signalling Radio Bearers (SRBs) and Data Radio Bearers (DRBs), Mobility, QoS management, Detection of and recovery from radio link failure, NAS message transfer etc.

SDAP: Mapping between a QoS flow and a data radio bearer, Marking QoS flow ID (QFI) in both DL and UL packets.

PDCP: Transfer of data, Header compression and decompression, Ciphering and deciphering, Integrity protection and integrity verification, Duplication, Reordering and in-order delivery, Out-of-order delivery etc.

RLC: Transfer of upper layer PDUs, Error Correction through ARQ, Segmentation and re-segmentation of RLC SDUs, Reassembly of SDU, RLC re-establishment etc.

MAC: Mapping between logical channels and transport channels, Multiplexing/demultiplexing of MAC SDUs belonging to one or different logical channels into/from transport blocks (TB) delivered to/from the physical layer on transport channels, Scheduling information reporting, Priority handling between UEs, Priority handling between logical channels of one UE etc.

PHY: Channel coding, Physical-layer hybrid-ARQ processing, Rate matching, Scrambling, Modulation, Layer mapping, Downlink Control Information, Uplink Control Information etc.

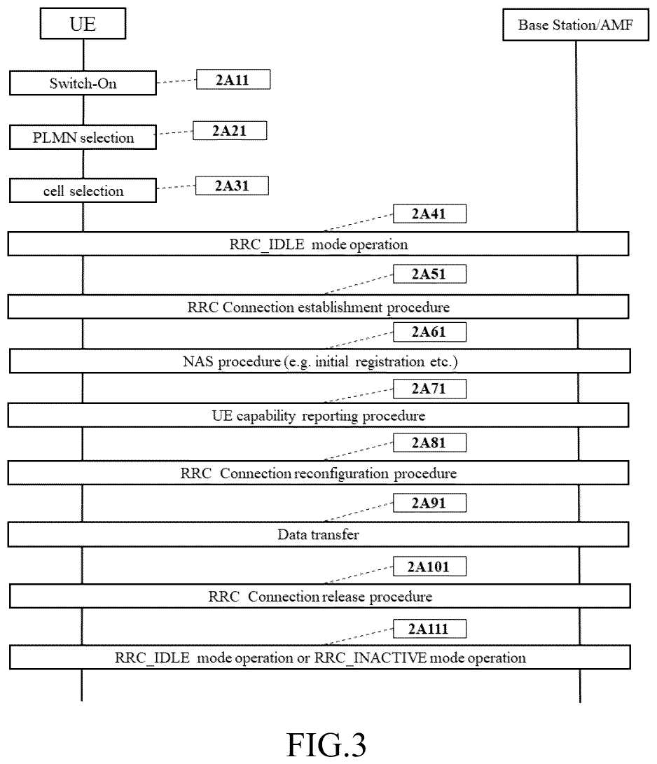

FIG. 3 illustrates overall operation of the UE and network.

Upon switch-on of the wireless device (e.g. UE) 2A11, UE performs PLMN selection 2A21 to select the carrier that is provided by the PLMN that UE is allowed to register.

Then UE performs cell selection 2A31 to camp on a suitable cell.

Once camping on a suitable cell, UE performs RRC_IDLE mode operation 2A41 such as paging channel monitoring and cell reselection and system information acquisition.

UE performs RRC Connection establishment procedure 2A51 to perform e.g. NAS procedure such as initial registration with the selected PLMN.

After successful RRC connection establishment, UE performs NAS procedure 2A61 by transmitting a corresponding NAS message via the established RRC connection (e.g. SRB1).

The base station can trigger UE capability reporting procedure 2A71 before configuring data bearers and various MAC functions.

The base station and the UE perform RRC connection reconfiguration procedure 2A81. Via the procedure, data radio bearers and logical channels and various MAC functions (such as DRX and BSR and PHR and beam failure reporting etc.) and various RRC functions (such as RRM and RLM and measurement etc.) are configured.

The base station and the UE perform data transfer 2A91 via the established radio bearers and based on configured MAC functions and configured RRC functions.

If geographical location of UE changes such that e.g. the current serving cell is no longer providing suitable radio condition, the base station and the UE perform cell level mobility such as handover or conditional reconfiguration or lower layer triggered mobility.

When RRC connection is not longer needed for the UE because of e.g. no more traffic available for the UE, the base station and the UE performs RRC connection release procedure 2A101. The base station can transit UE state either to RRC_IDLE (if the data activity of the UE is expected low) or to RRC_INACTIVE (if the data activity of the UE is expected high).

The UE performs either RRC_IDLE operation or RRC_INACTIVE mode operation 2A111 until the next event to RRC connection establishment/resumption occurs.

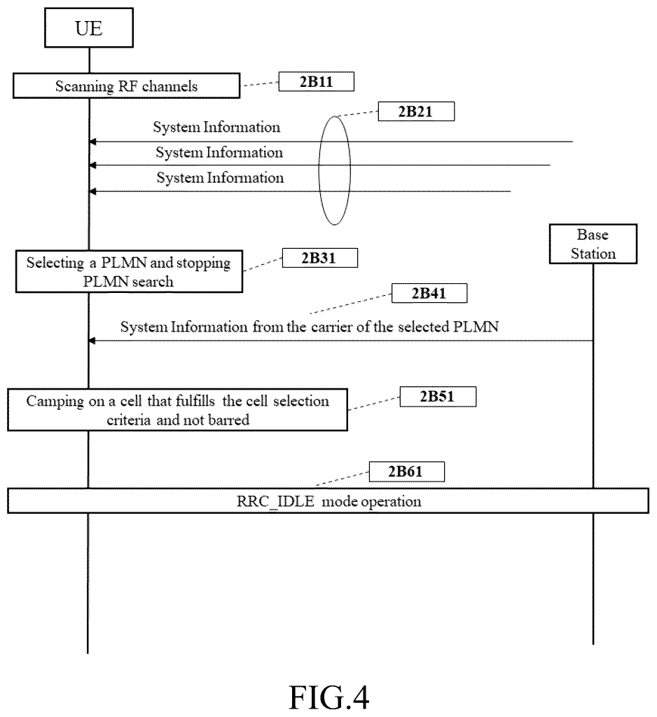

FIG. 4 illustrates the operation of the UE regarding PLMN selection and cell selection and cell reselection.

For PLMN selection, the UE may scan all RF channels to find available PLMNs 2B11. On each carrier, the UE shall search for the strongest cell and read its system information 2B21, in order to find out which PLMN(s) the cell belongs to. Each found PLMN is considered as a high quality PLMN (but without the RSRP value) provided that the measured RSRP value is greater than or equal to −110 dBm.

The search for PLMNs may be stopped when the PLMN to which the UE can register is found 2B31.

Once the UE has selected a PLMN, the cell selection procedure shall be performed in order to select a suitable cell of that PLMN to camp on.

The UE performs measurement on detectable cells and receives system information from whichever detectable cells that system information is readable 2B41.

The UE consider cell selection criterion S is fulfilled when:

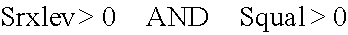

where, Srxlev is Cell selection RX level value (dB) and Squal is Cell selection quality value (dB). Srxlev is determined based on Measured cell RX level value (RSRP). Squal is determined based on Measured cell quality value (RSRQ).

The UE selects the cell that is part of the selected PLMN, and for which cell selection criteria are fulfilled, and of which cell access is not barred 2B51.

The UE camps on the selected cell. The UE perform RRC_IDLE mode operation 2B61 such as monitoring control channels to receive system information and paging and notification message.

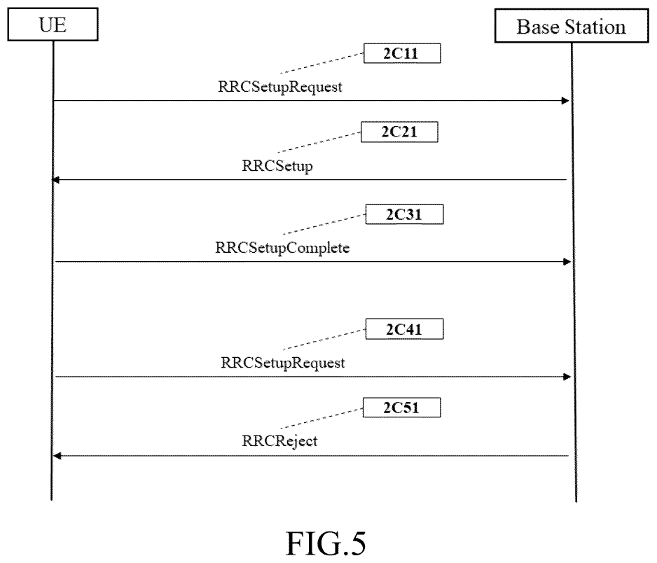

FIG. 5 illustrates RRC connection establishment procedure.

Successful RRC connection establishment procedure includes:
>1: transmission of RRCSetupRequest by the UE 2C11;
>1: reception of RRCSetup by the UE 2C21;
>1: transmission of RRCSetupComplete by the UE 2C31.

Unsuccessful RRC connection establishment procedure includes:
>1: transmission of RRCSetupRequest by the UE 2C41;
>1: reception of RRCReject by the UE 2C51;

RRCSetupRequest includes following fields and IEs:
>1: ue-Identity field contains InitialUE-Identity IE which contains:
>>2: ng-5G-S-TMSI-Part1 field containing a BIT STRING of 39 bit;
>1: establishmentCause field contains EstablishmentCause IE which contains:
>>2 enumerated value indicating either emergency, highPriorityAccess, mt-Access, mo-Signalling, mo-Data, mo-VoiceCall, mo-VideoCall, mo-SMS, mps-Priority Access, mcs-PriorityAccess etc

RRCSetup includes following fields and IEs:
>1: radioBearerConfig field containing a RadioBearerConfig IE;
>1: masterCellGroup field containing a CellGroupConfig IE.

RRCSetupComplete includes following fields and IEs:
>1: selectedPLMN-Identity field containing an integer indicating selected PLMN;
>1: dedicatedNAS-Message field containing a DedicatedNAS-Message which may contain various NAS message;
>1: ng-5G-S-TMSI-Part2 field containing a BIT STRING of 9 bit.

RRCSetupRequest is transmitted via CCCH/SRB0, which means that the base station does not identify UE transmitting the message based on DCI that scheduling the uplink transmission. The UE includes a field (ue-Identity) in the message so that the base station identify the UE. If 5G-S-TMSI is available (e.g. UE has already registered to a PLMN), the UE sets the field with part of the 5G-S-TMSI. If 5G-S-TMSI is not available (e.g. UE has not registered to any PLMN), the UE sets the field with 39-bit random value.

Upon reception of RRCSetup, UE configures cell group and SRB1 based on the configuration information in the RRCSetup. The UE perform following actions:
>1: perform the cell group configuration procedure in accordance with the received masterCellGroup;
>1: perform the radio bearer configuration procedure in accordance with the received radioBearerConfig;
>1: if stored, discard the cell reselection priority information provided by the cellReselectionPriorities or inherited from another RAT;
>1: enter RRC_CONNECTED;
>1: stop the cell re-selection procedure;
>1: consider the current cell to be the PCell;

The UE transmits to the base station RRCSetupComplete after performing above actions.

The UE sets the contents of RRCSetupComplete message as follows:
>1: set the ng-5G-S-TMSI-Value to ng-5G-S-TMSI-Part2;
>1: set the selectedPLMN-Identity to the PLMN selected by upper layers from the plmn-IdentityInfoList;
>1: include the s-NSSAI-List and set the content to the values provided by the upper layers;

For network to configure the UE with appropriate configurations, the network needs to know the capability of the UE. For this end, the UE and the base station perform UE capability transfer procedure.

UE capability transfer procedure consists of exchanging UECapabilityEnquiry 2D11 and UECapabilityInformation 2D21 between the UE and the base station.

In the UECapabiliityEnquiry, the base station indicates which RAT is subject to capability reporting. UE transmits the capability information for the requested RAT in the UECapability Information.

Once UECapabilityInformation is received, the capability information is uploaded to the AMF by the base station 2D31. When UE capability information is needed afterward, AMF provides it to the base station 2D41.

Based on the reported capability and other factors such as required QoS and call admission control etc, the base station performs RRC reconfiguration procedure with the UE.

RRC reconfiguration procedure is a general purposed procedure that are applied to various use cases such as data radio bearer establishment, handover, cell group reconfiguration, DRX configuration, security key refresh and many others.

RRC reconfiguration procedure consists of exchanging RRCReconfiguration 2E11 and RRCReconfigurationComplete 2E61 between the base station and the UE.

RRCReconfiguration may include following fields and IEs:
>1: rrc-TransactionIdentifier field contains a RRC-TransactionIdentifier IE;
>1: radioBearerConfig field contains a RadioBearerConfig IE;
>>2: radioBearerConfig field includes configuration information for SRBs and DRBs via which RRC messages and user traffic are transmitted and received;
>1: secondaryCellGroup field contains a CellGroupConfig IE;
>>2: secondaryCellGroup field includes configuration information for secondary cell group;
>>2: A cell group consists of a SpCell and zero or more SCells;
>>2: Cell group configuration information includes cell configuration information for SpCell/SCell and configuration information for MAC and configuration information for logical channel etc;
>1: measConfig field contains a MeasConfig IE;
>>2: measConfig field includes configuration information for measurements that the UE is required to perform for mobility and other reasons.
>1: masterCellGroup field contains a CellGroupConfig IE;

Upon reception of RRCReconfiguration, UE processes the IEs in the order as below. UE may:
>1: perform the cell group configuration for MCG based on the received masterCellGroup 2E21;
>1: perform the cell group configuration for SCG based on the received secondaryCellGroup 2E31;
>1: perform the radio bearer configuration based on the received radioBearerConfig 2E41;
>1: perform the measurement configuration based on the received measConfig 2E51;

After performing configuration based on the received IEs/fields, the UE transmits the RRCReconfigurationComplete to the base station. To indicate that the RRCReconfigurationComplete is the response to RRCReconfiguration, UE sets the TransactionIdentifier field of the RRCReconfigurationComplete with the value indicated in TransactionIdentifier field of the RRCReconfiguration.

The UE and the base station may perform procedures for power saving such as C-DRX 2F11. The configuration information for C-DRX is provided to the UE within cell group configuration in the RRCReconfiguration.

The UE and the base station may perform various procedures for downlink scheduling 2F21 such as CSI reporting and beam management. The configuration information for CSI reporting is provided to the UE within cell group configuration in the RRCReconfiguration. Beam management is performed across RRC layer and MAC layer and PHY layer. Beam related information is configured via cell group configuration information within RRCReconfiguration. Activation and deactivation of beam is performed by specific MAC CEs.

Based on the reported CSI and downlink traffic for the UE, the base station determines the frequency/time resource and transmission format for downlink transmission. The base station transmits to the UE DCI containing downlink scheduling information via PDCCH 2F31. The base station transmits to the UE PDSCH corresponding to the DCI and containing a MAC PDU 2F41.

The UE and the base station may perform various procedure for uplink scheduling 2F51 such as buffer status reporting and power headroom reporting and scheduling request and random access. The configuration information for those procedures are provided to the UE in cell group configuration information in RRCReconfiguration.

Based on the uplink scheduling information reported by the UE, the base station determines the frequency/time resource and transmission format for uplink transmission. The base station transmits to the UE DCI containing uplink scheduling information via PDCCH 2F61. The base station transmits to the UE PDSCH corresponding to the DCI and containing a MAC PDU 2F71.

RAN-assisted rate control provides a means for the gNB to send codec adaptation indication with recommended bit rate to assist the UE to select or adapt to a rate for MM traffic and/or XR traffic. The RAN-assisted codec adaptation mechanism supports the uplink/downlink bit rate increase or decrease.

For uplink or downlink bit rate adaptation, gNB may send a recommended bit rate to the UE to inform the UE on the currently recommended transport bit rate on the local uplink or downlink, which the UE may use in combination with other information to adapt the bit rate, e.g. the UE may send a bit rate request to the peer UE via application layer messages as specified in TS 26.114 [24], which the peer UE may use in combination with other information to adapt the codec bit rate. The recommended bit rate is in kbps at the physical layer at the time when the decision is made.

The recommended bit rate for UL and DL is conveyed as a MAC Control Element (CE) from the gNB to the UE. Based on the recommended bit rate from the gNB, a UE may initiate an end-to-end bit rate adaptation with its peer (UE or MGW). The UE may also send a query message to its local gNB to check if a bit rate recommended by its peer can be provided by the gNB. The UE is not expected to go beyond the recommended bit rate from the gNB.

The recommended bit rate query message is conveyed as a MAC CE from the UE to the gNB.

In conventional coarse-grained rate control, bit rate is controlled per direction per logical channel. The DL MAC CE_1 is used to indicate UL bit rate or DL bit rate of a logical channel. If UL bit rate is indicated, UE can adjust the UL bit rate of the logical channel accordingly. If DL bit rate is indicated, UE may send a bit rate request to the peer UE via application layer message. The UL MAC CE_1 is used to indicate UL bit rate or DL bit rate of a logical channel. The UL MAC CE_1 is transmitted when the UE receives from its peer recommended bit rate for traffic associated with the logical channel.

However, the existing coarse-grained rate control mechanism has limitations when applied to XR services. First, coarse-grained rate control operates at the logical channel granularity, which does not directly correspond to QoS flows. Since a single logical channel (or DRB) may carry multiple QoS flows with different QoS requirements, coarse-grained rate control cannot provide differentiated bitrate control for individual QoS flows.

Second, the 6-bit rate index used in coarse-grained rate control provides limited granularity for bitrate adjustment. The step size between n-th index and (n+1)-th index is approximately 13%, which may be too coarse for XR traffic that requires fine-grained bitrate adaptation to maintain quality while avoiding oscillations.

Third, when multiple PDU sessions are established for a UE, and each PDU session contains multiple QoS flows, the existing mechanism cannot efficiently signal bitrate recommendations for specific combinations of PDU session and QoS flow.

With the introduction of XR services, the existing coarse-grained rate control mechanism alone cannot adequately support the diverse and stringent requirements of XR traffic. The fine-grained rate control mechanism was introduced to address these limitations.

In fine-grained rate control, bit rate is controlled per direction per QoS flow. The DL MAC CE_2 is used to indicate UL bit rate or DL bit rate of one or more QoS flows of a PDU session. If UL bit rate is indicated, UE can adjust the UL bit rate for the QoS flow accordingly. If DL bit rate is indicated, UE may send a bit rate request to the peer UE via application layer message. The UL MAC CE_2 is used to indicate UL bit rate or DL bit rate of one or more QoS flows of a PDU session. The UL MAC CE_2 is transmitted when the UE receives from its peer recommended bit rate for the traffic associated with the QoS flows.

The fine-grained rate control mechanism provides several key advantages. First, it enables per-QoS flow bitrate control within a PDU session. This is particularly important for XR services where different media components (e.g., video, audio, haptic feedback) transmitted as separate QoS flows may have different bitrate adaptation requirements.

Second, 7-bit rate index is used in fine-grained rate control, compared to 6-bit bit rate index used in coarse-grained rate control. The 7-bit index provides finer granularity with a step size of approximately 10% between consecutive indices, compared to approximately 13% in coarse-grained rate control. This finer granularity enables more precise bitrate adjustments suitable for XR traffic.

Third, fine-grained rate control introduces a Combined Identifier (CID) that collectively indicates both QFI and PDU session ID. This CID enables the gNB to provide bitrate recommendations for specific QoS flows within specific PDU sessions, addressing the identification problem that exists in coarse-grained rate control.

Fourth, fine-grained rate control supports more frequent and responsive bitrate adaptation through the use of prohibit timers configured per QoS flow (bitRateQueryProhibitTimer_2) rather than per logical channel. This allows independent rate control for multiple QoS flows even when they are mapped to the same logical channel.

Despite the improvements provided by fine-grained rate control, there remains a need for clearly defined procedures for utilizing the CID to simultaneously identify PDU session and QoS flow, and for leveraging the different granularities of bitrate indices in coarse-grained rate control and fine-grained rate control.

Therefore, there is a need for an enhanced rate control mechanism that can: (1) efficiently utilize the CID for simultaneous identification of PDU session and QoS flow, (2) effectively exploit the different granularities of bitrate indices in coarse-grained rate control (6-bit with ~13% steps) and fine-grained rate control (7-bit with ~10% steps) to accommodate diverse service requirements, and (3) provide detailed UE and gNB operational procedures for implementing these enhancements.

The present invention provides an enhanced RAN-assisted rate control mechanism for wireless communication systems. RAN-assisted rate control provides a means for the gNB to send codec adaptation indication with recommended bit rate to assist the UE to select or adapt to a rate for MM traffic and/or XR traffic. The RAN-assisted codec adaptation mechanism supports the uplink/downlink bit rate increase or decrease.

The wireless communication system includes a User Equipment (UE), a base station (gNB), and a core network. The UE communicates with the gNB via a radio interface, and the gNB is connected to the core network. The UE may be a device capable of supporting XR services, such as a smartphone, tablet, XR headset, or other mobile device.

The UE establishes one or more PDU sessions with the core network through the gNB, and each PDU session may contain one or more QoS flows for transmitting different types of traffic. The gNB monitors radio channel conditions and traffic characteristics for the UE, and provides bitrate recommendations to the UE through rate control messages.

The system supports two types of rate control mechanisms: coarse-grained rate control and fine-grained rate control. In coarse-grained rate control, bit rate is controlled per direction per logical channel. The 6-bit rate index is used in coarse-grained rate control, and in the first table associated with coarse-grained rate control, the step size between n-th index and (n+1)-th index is approximately 13%.

In fine-grained rate control, bit rate is controlled per direction per QoS flow. The 7-bit rate index is used in fine-grained rate control, and in the second table associated with fine-grained rate control, the step size between n-th index and (n+1)-th index is approximately 10%. This finer granularity enables more precise bitrate adjustments suitable for XR traffic.

The DL MAC CE_1 is the Recommended bit rate MAC CE transmitted by the gNB for coarse-grained rate control. The UL MAC CE_1 is the Recommended bit rate MAC CE transmitted by the UE for coarse-grained rate control. The DL MAC CE_2 is the Extended Recommended bit rate MAC CE transmitted by the gNB for fine-grained rate control. The UL MAC CE_2 is the Extended Recommended bit rate MAC CE transmitted by the UE for fine-grained rate control.

In coarse-grained rate control, a prohibit timer can be configured per logical channel by the network to limit UEs sending frequent query MAC CEs. Independent prohibit timers are used for each direction (uplink and downlink) to prohibit the UE from retransmitting exactly the same query MAC CE to the gNB during the configured time.

In fine-grained rate control, a prohibit timer can be configured per QoS flow by the network to limit UEs sending frequent query MAC CEs. Independent prohibit timers are used for each direction (uplink and downlink) to prohibit the UE from retransmitting exactly the same query MAC CE to the gNB during the configured time.

According to an embodiment of the present invention, the Extended Recommended bit rate MAC CE used in fine-grained rate control includes a CID field. The CID field indicates the collective identity of a pair of QFI and PDU session ID for which the recommended bit rate or the recommended bit rate query is applicable. The length of the CID field is 6 bits.

The CID enables the gNB to provide bitrate recommendations at the granularity of individual QoS flows within specific PDU sessions. When the gNB generates an Extended Recommended bit rate MAC CE, it includes the CID corresponding to the target PDU session and QoS flow. Upon receiving the message, the UE uses the CID to identify the specific traffic flow to which the bitrate recommendation applies.

The CID value can be determined through multiple methods. In a first method, the mapping between CID values and (PDU Session ID, QFI) pairs is explicitly configured through RRC (Radio Resource Control) signaling. The gNB sends configuration information to the UE in a rate_control_2_config IE, defining which CID value (referred to as “collective identity”) corresponds to which PDU session and QoS flow combination. The UE stores this mapping information and uses it to interpret CID values received in rate control messages.

In a second method, the CID value is automatically derived from the QFI and PDU session ID according to a predetermined rule. For example, the CID may be calculated using a formula such as: CID=(PDU_Session_ID×K)+QFI, where K is a predefined constant (e.g., K=64 to accommodate all possible QFI values). Alternatively, the CID may be formed by concatenating specific bits from the PDU session ID and QFI fields. For instance, if the CID field is 6 bits, the upper 3 bits may represent a portion of the PDU session ID and the lower 3 bits may represent a portion of the QFI. Another formula could be: CID=(PDU_Session_ID mod M)×N+(QFI mod N), where M and N are predefined modulo values suitable for the 6-bit CID space. This automatic derivation method eliminates the need for explicit configuration signaling and provides a deterministic relationship between CID and the (PDU Session ID, QFI) pair.

In a third method, a hybrid approach may be used where certain CID values are explicitly configured while others are automatically derived according to the predetermined rule. This provides flexibility for the network to handle both standard QoS flow configurations and special cases requiring explicit mapping.

Alternatively, the Extended Recommended bit rate MAC CE may include separate PDU session ID field and QFI field instead of using the CID field. The PDU session ID field indicates the PDU session that is associated with the QoS flows for which bit rate is recommended/queried. The QFI field indicates the identity of a QoS flow for which the recommended bit rate or the recommended bit rate query is applicable. The length of the QFI field is 6 bits.

The UE determines the PDU session that is associated with the QFI based on RRC configuration (e.g., QFI of the PDU session that is associated with the radio bearer where fine-grained rate control is configured), if the PDU session ID field is not present. The UE determines the PDU session associated with the QFI based on the PDU session ID field if present.

By using either the CID approach (with explicit configuration or automatic derivation) or the separate PDU session ID and QFI fields, the system achieves simultaneous identification of both PDU session and QoS flow, enabling precise bitrate control for individual traffic flows within a multi-service environment.

F100 illustrates a format of Recommended bit rate MAC CE for coarse-grained rate control.

The Recommended bit rate MAC CE for coarse-grained rate control is identified by a MAC subheader with LCID as specified in specification tables for bit rate recommendation message from the gNB to the UE and bit rate recommendation query message from the UE to the gNB, respectively. It has a fixed size and consists of two octets defined as follows:

The LCID field indicates the identity of the logical channel for which the recommended bit rate or the recommended bit rate query is applicable. The length of the field is 6 bits.

The Uplink/Downlink (u/d) field indicates whether the recommended bit rate or the recommended bit rate query applies to uplink or downlink. The length of the field is 1 bit. This field set to 0 indicates downlink. This field set to 1 indicates uplink.

The Bit Rate field indicates an index to the first table. The length of the field is 6 bits. In the first table, the step size between n-th index and (n+1)-th index is approximately 13%. For bit rate recommendation, the value indicates the recommended bit rate. For bit rate recommendation query, the value indicates the desired bit rate.

The X field is the bit rate multiplier. For UEs supporting recommended bit rate multiplier, when bitRateMultiplier is configured for the logical channel indicated by the LCID field, the X field set to 1 indicates the actual value of bit rate is the value corresponding to the index indicated by the Bit Rate field multiplied by bitRateMultiplier as specified in TS 38.331.

The R field is a reserved bit, set to 0.

F200 and F300 illustrate formats of Extended Recommended bit rate MAC CE for fine-grained rate control.

The Extended Recommended bit rate MAC CE for fine-grained rate control is identified by a MAC subheader with eLCID for bit rate recommendation message from the gNB to the UE and bit rate recommendation query message from the UE to the gNB, respectively. It has variable size.

The CID field indicates the collective identity of a pair of QFI and PDU session ID for which the recommended bit rate or the recommended bit rate query is applicable. The length of the field is 6 bits.

Alternatively, the PDU session ID field indicates the PDU session that is associated with the QoS flows for which bit rate is recommended/queried. The QFI field indicates the identity of a QoS flow for which the recommended bit rate or the recommended bit rate query is applicable. The length of the field is 6 bits.

The Uplink/Downlink (u/d) field indicates whether the recommended bit rate or the recommended bit rate query applies to uplink or downlink. The length of the field is 1 bit. This field set to 0 indicates downlink. This field set to 1 indicates uplink.

The Bit Rate field indicates an index to the second table. The length of the field is 7 bits. In the second table, the step size between n-th index and (n+1)-th index is approximately 10%. For bit rate recommendation, the value indicates the recommended bit rate. For bit rate recommendation query, the value indicates the desired bit rate.

The X field is the bit rate multiplier. For UEs supporting recommended bit rate multiplier, when bitRateMultiplier_2 is configured for the QoS flow indicated by the CID field or QFI field, the X field set to 1 indicates the actual value of bit rate is the value corresponding to the index indicated by the Bit Rate field multiplied by bitRateMultiplier_2 as specified in TS 38.331.

The E field indicates whether additional bit rate information follows. If set to 1, bit rate information [CID (or QFI), u/d, bit rate, X and E field] follows in the next two octets. If set to 0, it is the last octet (or last bit rate information) and the bit rate information does not follow. This enables the Extended Recommended bit rate MAC CE to include bitrate recommendations for multiple QoS flows in a single MAC CE.

At S100, the UE transmits to the gNB a UECapabilityInformation message. The UE includes in the message a first IE if the UE supports coarse-grained rate control. The UE includes in the message a second IE if the UE supports fine-grained rate control. This allows the gNB to determine which rate control mechanisms are supported by the UE and configure them appropriately.

At S200, the gNB transmits to the UE an RRCReconfiguration message to configure rate control parameters.

If coarse-grained rate control is applied to one or more logical channels, the gNB includes bitRateQueryProhibitTimer and bitRateMultiplier in each LogicalChannelConfig corresponding to each of the one or more logical channels.

If fine-grained rate control is applied to one or more QoS flows of a specific PDU session, the gNB includes specific fields/IEs in each RadioBearerConfig corresponding to each of the one or more QoS flows. The specific fields/IEs include: bitRateQueryProhibitTimer_2, bitRateMultiplier_2, and list of QFIs.

Alternatively, if fine-grained rate control is applied to one or more QoS flows of a specific PDU session, the gNB includes a rate_control_2_config IE in the RRCReconfiguration message.

The rate_control_2_config IE includes following fields/IEs: PDU session ID, and List of rate control configuration. Each rate control configuration includes: QoS flow ID (QFI); collective identity: an identity for the QoS flow, where this ID collectively indicates QFI and PDU session ID; bitRateQueryProhibitTimer_2: the timer is used for extended bit rate recommendation query for this QoS flow, in seconds (value s0 means 0 s, s0dot4 means 0.4 s and so on); bitRateMultiplier_2: bit rate multiplier for extended recommended bit rate MAC CE for this QoS flow (value ×40 indicates bit rate multiplier 40, value ×70 indicates bit rate multiplier 70 and so on).

This RRC configuration establishes the mapping between CID values and (PDU Session ID, QFI) combinations, as well as the parameters needed for bitrate index interpretation and prohibit timer operation.

When uplink congestion occurs or when channel conditions change significantly, the gNB determines to adjust uplink or downlink data rate.

If one or more logical channels subject to coarse-grained rate control are to be controlled, the gNB generates one or more Recommended bit rate MAC CEs. The gNB transmits the one or more Recommended bit rate MAC CEs within one or more MAC PDUs at S300.

If one or more QoS flows subject to fine-grained rate control are to be controlled, the gNB generates an Extended Recommended bit rate MAC CE. The gNB transmits the Extended Recommended bit rate MAC CE at S300.

At S400, in case that MAC CE for downlink rate control is received, UE performs downlink rate control operation.

At S500, in case that MAC CE for uplink rate control is received, UE performs uplink rate control operation.

At S600, if required for rate control, UE transmits rate control MAC CE.

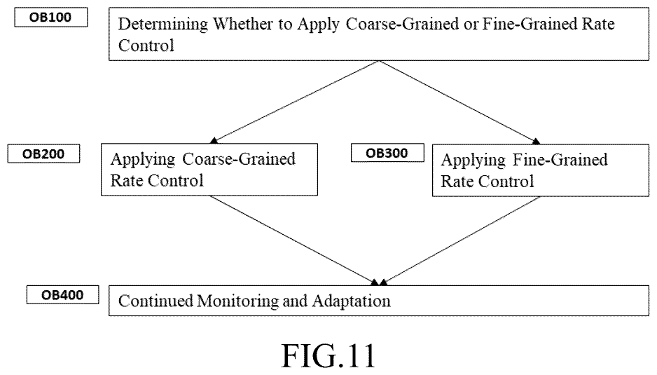

FIG. 11 illustrates operations of base station for rate control.

According to an embodiment of the present invention, the gNB operation for providing rate control comprises the following steps:

### Step 1: Determining Whether to Apply Coarse-Grained or Fine-Grained Rate Control

At OB100, the gNB monitors radio channel conditions and traffic characteristics for each UE. The monitoring includes measuring uplink and downlink channel quality indicators (CQI, RSRP, RSRQ), tracking channel variations, observing buffer status for each QoS flow, measuring actual throughput and packet delay, and detecting congestion or underutilization. Based on the monitoring results, the gNB determines whether bitrate adjustment is needed. The gNB then determines whether to apply coarse-grained rate control or fine-grained rate control based on the following criteria: (a) if the traffic is associated with a specific logical channel and the UE has reported support for coarse-grained rate control, the gNB considers applying coarse-grained rate control; (b) if the traffic is associated with a specific QoS flow and the UE has reported support for fine-grained rate control, the gNB considers applying fine-grained rate control; (c) if the traffic requires fine-grained bitrate control (e.g., XR traffic with stringent QoS requirements), the gNB preferentially selects fine-grained rate control due to its finer 7-bit granularity (~10% steps); (d) if the traffic can tolerate coarser bitrate adjustments (e.g., general multimedia traffic), the gNB may select coarse-grained rate control to reduce signaling overhead; (e) if multiple QoS flows within the same PDU session require differentiated bitrate control, the gNB selects fine-grained rate control to leverage the CID-based identification mechanism.

### Step 2: Applying Coarse-Grained Rate Control

If the gNB determines to apply coarse-grained rate control in OB100, at OB200 the gNB performs the following operations for coarse-grained rate control: (a) the gNB identifies one or more logical channels that require bitrate adjustment; (b) for each identified logical channel, the gNB calculates the recommended bitrate based on estimated sustainable bitrate given current channel conditions, QoS requirements and priority of the traffic flow, and resource availability and scheduling constraints; (c) the gNB determines a 6-bit bit-rate index corresponding to the recommended bitrate using the first table where the step size between n-th index and (n+1)-th index is approximately 13%; (d) the gNB determines the value of the X field based on whether bitRateMultiplier is configured for the logical channel and whether the multiplier should be applied; (e) the gNB generates one or more Recommended bit rate MAC CEs (DL MAC CE_1), where each MAC CE includes: the LCID field identifying the target logical channel, the u/d field set to 0 for downlink or 1 for uplink, the 6-bit Rate field containing the calculated index, the X field for bitrate multiplier indication, and the R field set to 0; (f) the gNB transmits the one or more Recommended bit rate MAC CEs within one or more MAC PDUs to the UE.

### Step 3: Applying Fine-Grained Rate Control

If the gNB determines to apply fine-grained rate control in OB100, at OB300, the gNB performs the following operations for fine-grained rate control: (a) the gNB identifies one or more QoS flows that require bitrate adjustment, along with their associated PDU sessions; (b) for each identified QoS flow, the gNB calculates the recommended bitrate based on estimated sustainable bitrate given current channel conditions, QoS requirements and priority of the specific QoS flow, and resource availability and scheduling constraints; (c) the gNB determines a 7-bit bit-rate index corresponding to the recommended bitrate using the second table where the step size between n-th index and (n+1)-th index is approximately 10%; (d) the gNB determines the value of the X field based on whether bitRateMultiplier_2 is configured for the QoS flow and whether the multiplier should be applied; (e) for each QoS flow, the gNB generates the CID value that collectively identifies the PDU session ID and QFI: either by looking up the configured collective identity from the rate_control_2_config IE sent during RRC configuration, or by automatically deriving the CID from the PDU session ID and QFI according to a predetermined rule (e.g., CID=(PDU_Session_ID×K)+QFI); alternatively, the gNB may include separate PDU session ID and QFI fields instead of using CID; (f) the gNB generates an Extended Recommended bit rate MAC CE (DL MAC CE_2) that includes one or more instances of bit rate information, where each instance comprises: the CID field (or PDU session ID and QFI fields) identifying the target QoS flow and PDU session, the u/d field set to 0 for downlink or 1 for uplink, the 7-bit Rate field containing the calculated index, the X field for bitrate multiplier indication, and the E field set to 1 if additional bit rate information follows or 0 if this is the last instance; (g) the gNB transmits the Extended Recommended bit rate MAC CE within a MAC PDU to the UE, where the MAC CE is identified by a specific eLCID in the MAC subheader.

### Step 4: Continued Monitoring and Adaptation

At OB400, after transmitting the rate control MAC CE (either type 1 or type 2), the gNB continues to monitor the UE's traffic to assess whether the bitrate recommendation was effective. The gNB observes changes in throughput, buffer status, and channel quality following the rate control message. If channel conditions or traffic characteristics change significantly, the gNB returns to Step 1 to determine whether additional bitrate adjustment is needed and which rate control mechanism to apply. The gNB may adjust the rate control strategy based on observed UE behavior and feedback, learning optimal recommendation policies over time.

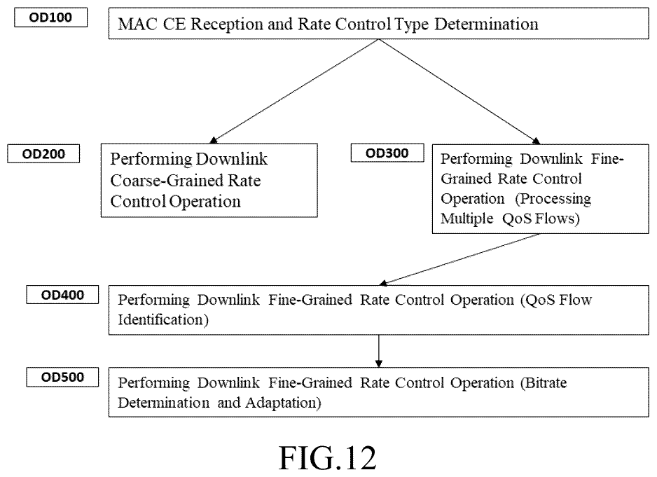

FIG. 12 illustrates operations of terminal for downlink rate control.

According to an embodiment of the present invention, the UE operation for handling downlink rate control comprises the following steps:

### Step 1: MAC CE Reception and Rate Control Type Determination

At OD100, the UE receives a DL MAC CE from the gNB within a MAC PDU. The UE processes the MAC subheaders in the MAC PDU to identify the types of MAC CEs present. The UE examines the LCID field in each MAC subheader to determine the MAC CE type. The UE determines whether the received DL MAC CE corresponds to coarse-grained rate control or fine-grained rate control based on the following criteria: (a) if the MAC subheader contains a specific LCID value designated for Recommended bit rate MAC CE, the UE identifies this as a first type MAC CE corresponding to coarse-grained rate control; (b) if the MAC subheader contains a specific LCID value indicating the presence of eLCID, and the eLCID value designates Extended Recommended bit rate MAC CE, the UE identifies this as a second type MAC CE corresponding to fine-grained rate control. Based on this determination, if the DL MAC CE is the first type MAC CE, the UE proceeds to perform downlink coarse-grained rate control operation; if the DL MAC CE is the second type MAC CE, the UE proceeds to perform downlink fine-grained rate control operation.

### Step 2: Performing Downlink Coarse-Grained Rate Control Operation

If the UE determined in OD100 that the received MAC CE is the first type (coarse-grained rate control), at OD200, the UE performs downlink coarse-grained rate control operation for a logical channel as follows: (a) the UE extracts the fields from the Recommended bit rate MAC CE, including the LCID field (6 bits), the u/d field (1 bit), the Bit Rate field (6 bits), the X field, and the R field; (b) the UE determines the recommended bit rate based on the 6-bit bit-rate index from the Bit Rate field, the X field, and the first table where the step size between n-th index and (n+1)-th index is approximately 13%; if X is set to 0, the recommended bitrate is obtained directly from the first table using the Bit Rate index; if X is set to 1 and bitRateMultiplier is configured for the logical channel, the recommended bitrate is calculated as (value from first table for Bit Rate index)×bitRateMultiplier; (c) the UE identifies the logical channel based on the LCID field and determines the upper layer associated with this logical channel; (d) if the u/d field indicates uplink (set to 1), the UE adjusts the uplink data rate of the upper layer according to the recommended bit rate, which may involve sending a bitrate adaptation request to the application layer and adjusting codec encoding parameters; (e) if the u/d field indicates downlink (set to 0), the UE initiates an end-to-end bit rate adaptation with its peer according to the recommended bit rate, which may involve sending application-layer signaling to the peer device to request bitrate adjustment.

### Step 3: Performing Downlink Fine-Grained Rate Control Operation

If the UE determined in OD100 that the received MAC CE is the second type (fine-grained rate control), at OD300, the UE performs downlink fine-grained rate control operation for one or more QoS flows. The Extended Recommended bit rate MAC CE may contain multiple instances of bit rate information due to the E field mechanism. The UE processes each instance sequentially: (a) the UE extracts the first instance of bit rate information from the Extended Recommended bit rate MAC CE, including the CID field (or PDU session ID and QFI fields), the u/d field, the Bit Rate field (7 bits), the X field, and the E field; (b) the UE performs steps 4 and 5 (described below) for this first instance; (c) if the E field of the current instance is set to 1, indicating that additional bit rate information follows, the UE extracts the next instance of bit rate information and repeats the processing; (d) the UE continues this process until it encounters an instance where the E field is set to 0, indicating this is the last bit rate information in the MAC CE.

### Step 4: Performing Downlink Fine-Grained Rate Control Operation

At OD400, for each instance of bit rate information in the Extended Recommended bit rate MAC CE (as identified in OD300), the UE performs the following to identify the target QoS flow: (a) if the bit rate information includes a CID field, the UE determines the QoS flow associated with this bit rate information based on the Collective ID (CID); the UE looks up the CID value in the mapping table configured via RRC signaling (rate_control_2_config IE) to find the corresponding PDU Session ID and QFI pair; alternatively, if the CID is automatically derived, the UE applies the predetermined rule to extract the PDU session ID and QFI from the CID value (e.g., using the inverse of the formula CID=(PDU_Session_ID×K)+QFI to recover PDU_Session_ID and QFI); (b) if the bit rate information includes separate PDU session ID field and QFI field, the UE determines the QoS flow directly from these fields; if the PDU session ID field is not present, the UE determines the PDU session based on RRC configuration (e.g., the PDU session associated with the radio bearer where fine-grained rate control is configured); (c) the UE thereby identifies the specific QoS flow (characterized by the PDU Session ID and QFI pair) to which the bitrate recommendation applies.

### Step 5: Performing Downlink Fine-Grained Rate Control Operation-Bitrate Determination and Adaptation

At OD500, after identifying the target QoS flow in Step 4, the UE performs the following for bitrate determination and adaptation: (a) the UE determines the recommended bit rate for the QoS flow based on the bit rate information and the second table where the step size between n-th index and (n+1)-th index is approximately 10%; if the X field is set to 0, the recommended bitrate is obtained directly from the second table using the 7-bit Rate index; if the X field is set to 1 and bitRateMultiplier_2 is configured for the QoS flow, the recommended bitrate is calculated as (value from second table for Bit Rate index)×bitRateMultiplier_2; (b) the UE determines the upper layer associated with the identified QoS flow; (c) if the u/d field indicates uplink (set to 1), the UE adjusts the uplink data rate of the upper layer according to the recommended bit rate, which may involve sending a bitrate adaptation request to the application layer, adjusting codec encoding parameters (e.g., quantization level, frame rate, resolution), and updating scheduling request parameters if needed; (d) if the u/d field indicates downlink (set to 0), the UE initiates an end-to-end bit rate adaptation with its peer according to the recommended bit rate, which may involve sending application-layer signaling to the peer device (e.g., via RTCP messages as specified in TS 26.114) to request bitrate adjustment.

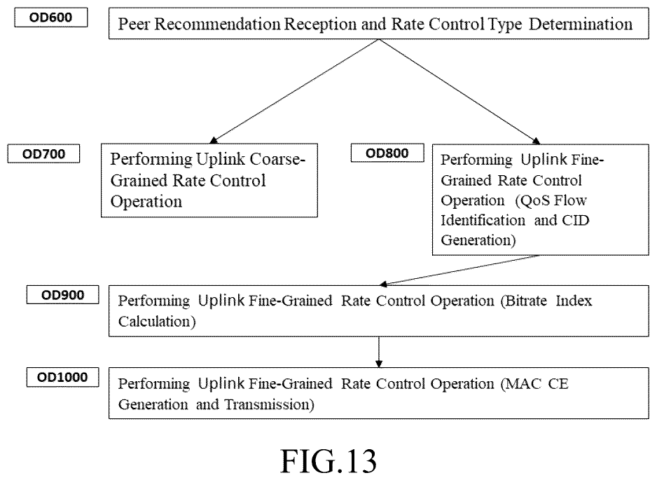

FIG. 13 illustrates operations of terminal for uplink rate control.

According to an embodiment of the present invention, the UE operation for handling uplink rate control comprises the following steps:

### Step 1: Peer Recommendation Reception and Rate Control Type Determination

At OD600, the UE receives a bit rate recommendation from its peer (peer UE or MGW) via application layer messages. The UE compares the recommended bit rate from the peer with the current bit rate. If the recommended bit rate from the peer is different from the current bit rate, the UE determines whether to perform uplink coarse-grained rate control or uplink fine-grained rate control based on the following criteria: (a) if the recommended bit rate from the peer is associated with a specific logical channel, the UE determines to perform uplink coarse-grained rate control; (b) if the recommended bit rate from the peer is associated with a specific QoS flow, the UE determines to perform uplink fine-grained rate control. Based on this determination, the UE proceeds to either Step 2 for uplink coarse-grained rate control operation or Step 3 for uplink fine-grained rate control operation.

### Step 2: Performing Uplink Coarse-Grained Rate Control Operation

If the UE determined in OD600 to perform uplink coarse-grained rate control, at OD700, the UE performs the following operations: (a) the UE determines the logical channel for which bit rate is to be queried based on the association of the peer's recommendation with the logical channel; (b) the UE determines a value for the X field and a 6-bit bit-rate index corresponding to the recommended bit rate from the peer based on the bitRateMultiplier field configured for the logical channel and the first table where the step size between n-th index and (n+1)-th index is approximately 13%; if bitRateMultiplier is not configured or the recommended bitrate can be represented without using the multiplier, the UE sets X=0 and finds the index in the first table that most closely matches the recommended bitrate; if bitRateMultiplier is configured and the recommended bitrate is high enough to benefit from the multiplier, the UE sets X=1 and finds the index such that (value from first table for the index) x bitRateMultiplier approximates the recommended bitrate; (c) the UE sets the u/d field according to the direction indicated by its peer (set to 0 for downlink or 1 for uplink); (d) the UE generates a Recommended bit rate MAC CE (UL MAC CE_1) including the LCID field identifying the logical channel, the u/d field, the 6-bit Rate field containing the determined index, the X field, and the R field set to 0; (e) before transmitting, the UE checks if bitRateQueryProhibitTimer for the logical channel and the direction is running; if the timer is running, the UE does not transmit the MAC CE and waits until the timer expires; (f) if the MAC entity has UL resources allocated for new transmission and the allocated UL resources can accommodate the Recommended bit rate MAC CE plus its subheader as a result of LCP, the UE transmits the MAC CE within a MAC PDU and starts bitRateQueryProhibitTimer for the logical channel and the direction.

### Step 3: Performing Uplink Fine-Grained Rate Control Operation

If the UE determined in OD600 to perform uplink fine-grained rate control, at OD800, the UE performs the following operations: (a) the UE determines the QoS flow for which bit rate is to be queried based on the association of the peer's recommendation with the QoS flow; this identifies the PDU Session ID and QFI of the target QoS flow; (b) the UE generates the identifier for the QoS flow to include in the Extended Recommended bit rate MAC CE using one of the following methods: Method 1—if the CID field is to be used, the UE determines the CID value that collectively indicates the QFI and PDU session ID; if explicit CID mapping was configured via RRC signaling (rate_control_2_config IE), the UE looks up the collective identity corresponding to the (PDU Session ID, QFI) pair; if automatic CID derivation is used, the UE calculates the CID from the PDU session ID and QFI according to the predetermined rule (e.g., CID=(PDU_Session_ID×K)+QFI); Method 2—alternatively, the UE may use separate PDU session ID field and QFI field to indicate the QoS flow instead of using the CID field.

### Step 4: Performing Uplink Fine-Grained Rate Control Operation

At OD900, the UE determines a value for the X field and a 7-bit bit-rate index corresponding to the recommended bit rate from the peer based on the bitRateMultiplier_2 field configured for the QoS flow and the second table where the step size between n-th index and (n+1)-th index is approximately 10%. If bitRateMultiplier_2 is not configured or the recommended bitrate can be represented without using the multiplier, the UE sets X=0 and finds the index in the second table that most closely matches the recommended bitrate. If bitRateMultiplier_2 is configured and the recommended bitrate is high enough to benefit from the multiplier, the UE sets X=1 and finds the index such that (value from second table for the index)×bitRateMultiplier_2 approximates the recommended bitrate. The UE sets the u/d field according to the direction indicated by its peer (set to 0 for downlink or 1 for uplink).

### Step 5: Performing Uplink Fine-Grained Rate Control Operation

At OD1000, the UE performs the following: (a) the UE generates an Extended Recommended bit rate MAC CE (UL MAC CE_2) including the bit rate information comprising: the CID field (or PDU session ID and QFI fields) as determined in Step 3, the u/d field, the 7-bit Rate field containing the determined index, the X field as determined in Step 4, and the E field; (b) if the UE needs to query bitrates for multiple QoS flows simultaneously, the UE may include multiple instances of bit rate information in the same Extended Recommended bit rate MAC CE by setting the E field to 1 for all instances except the last, and setting E to 0 for the final instance; (c) before transmitting, the UE checks if bitRateQueryProhibitTimer_2 for at least one QoS flow included in the MAC CE and the direction is running; if the timer is running, the UE does not transmit the MAC CE and waits until the timer expires; (d) if the MAC entity has UL resources allocated for new transmission and the allocated UL resources can accommodate the Extended Recommended bit rate MAC CE plus its subheader as a result of LCP, the UE transmits the MAC CE within a MAC PDU; (e) upon transmission, the UE starts a specific bitRateQueryProhibitTimer_2; the specific bitRateQueryProhibitTimer_2 is the shortest (or longest) bitRateQueryProhibitTimer_2 among timers associated with the QoS flows queried in the MAC CE.

The recommended bit rate procedure for coarse-grained rate control is used to provide the MAC entity with information about the bit rate which the gNB recommends. The bit rate is the recommended bit rate of the physical layer. An averaging window of default value 2000 ms will apply as specified in TS 26.114 [13].

The gNB may transmit the Recommended bit rate MAC CE to the MAC entity to indicate the recommended bit rate for the UE for a specific logical channel and a specific direction (either uplink or downlink). Upon reception of a Recommended bit rate MAC CE, the MAC entity shall indicate to upper layers the recommended bit rate for the indicated logical channel and direction.

The MAC entity may request the gNB to indicate the recommended bit rate for a specific logical channel and a specific direction by transmitting a Recommended bit rate MAC CE. If the MAC entity is requested by upper layers to query the gNB for the recommended bit rate for a logical channel and for a direction (i.e., for uplink or downlink), the MAC entity shall: if a Recommended bit rate query for this logical channel and this direction has not been triggered, trigger a Recommended bit rate query for this logical channel, direction, and desired bit rate.

If the MAC entity has UL resources allocated for new transmission, the MAC entity shall: for each Recommended bit rate query that the Recommended Bit Rate procedure determines has been triggered and not cancelled: if bitRateQueryProhibitTimer for the logical channel and the direction of this Recommended bit rate query is configured, and it is not running; and if the MAC entity has UL resources allocated for new transmission and the allocated UL resources can accommodate a Recommended bit rate MAC CE plus its subheader as a result of LCP (Logical Channel Prioritization): instruct the Multiplexing and Assembly procedure to generate the Recommended bit rate MAC CE for the logical channel and the direction of this Recommended bit rate query; start the bitRateQueryProhibitTimer for the logical channel and the direction of this Recommended bit rate query; cancel this Recommended bit rate query.

The recommended bit rate procedure for fine-grained rate control is used to provide the MAC entity with information about the bit rate which the gNB recommends. The bit rate is the recommended bit rate of the physical layer. An averaging window of default value 2000 ms will apply as specified in TS 26.114 [13].

The gNB may transmit the Extended Recommended bit rate MAC CE to the MAC entity to indicate the recommended bit rate for the UE for a specific set of QoS flows. Upon reception of an Extended Recommended bit rate MAC CE, the MAC entity shall indicate to upper layers the recommended bit rate for the indicated QoS flows and directions.

The MAC entity may request the gNB to indicate the recommended bit rate for a specific set of QoS flows by transmitting an Extended Recommended bit rate MAC CE. If the MAC entity is requested by upper layers to query the gNB for the recommended bit rate for the specific set of QoS flows, the MAC entity shall: if an Extended Recommended bit rate query for at least one QoS flow and for this direction has not been triggered, trigger an Extended Recommended bit rate query for this QoS flow, direction, and desired bit rate.

If the MAC entity has UL resources allocated for new transmission, the MAC entity shall: for each Extended Recommended bit rate query that the extended Recommended Bit Rate procedure determines has been triggered and not cancelled: if bitRateQueryProhibitTimer_2 for at least one QoS flow and the direction of this extended Recommended bit rate query is configured, and it is not running; and if the MAC entity has UL resources allocated for new transmission and the allocated UL resources can accommodate the Extended Recommended bit rate MAC CE plus its subheader as a result of LCP: instruct the Multiplexing and Assembly procedure to generate the Extended Recommended bit rate MAC CE for the logical channel and the direction of this Recommended bit rate query; start the bitRateQueryProhibitTimer_2 for the QoS flow and the direction of this Extended Recommended bit rate query; cancel this Extended Recommended bit rate query.

The rate control mechanism according to the present invention is particularly effective for XR services. XR traffic typically includes multiple media components (video, audio, haptic feedback, metadata) that may be transmitted as separate QoS flows within a PDU session.

For example, an XR application may establish a PDU session with the following QoS flows: (1) a high-priority video flow for the main viewport requiring 50-80 Mbps, (2) a lower-priority video flow for peripheral vision requiring 10-20 Mbps, (3) an audio flow requiring 128-256 kbps, and (4) a haptic feedback flow requiring 1-2 Mbps with very low latency.

Using the CID-based fine-grained rate control mechanism, the gNB can provide individual bitrate recommendations for each of these QoS flows. When channel conditions degrade, the gNB may reduce the bitrate recommendation for the peripheral video flow while maintaining the bitrate for the main viewport video and haptic feedback, thereby preserving the most critical aspects of the XR experience.

The fine granularity of fine-grained rate control (7-bit index with approximately 10% step size) enables smooth bitrate adaptation without causing perceptible quality jumps or oscillations. For instance, the main viewport video bitrate can be adjusted in smaller increments compared to coarse-grained rate control, allowing gradual adaptation to channel variations while maintaining visual continuity.

A PDU Session is a logical connection established between the 5G core network and a UE, serving as a channel for packet transmission to a specific Data Network (DN). A single PDU session is identified by a PDU session ID. A UE can have multiple PDU sessions simultaneously, and each PDU session can be connected to different data networks.

A QoS Flow is the minimum granularity for distinguishing and transmitting traffic with specific QoS requirements within a PDU session. A single PDU session can contain multiple QoS flows, and each QoS flow is identified by a QFI (QoS Flow Identifier). For example, in XR services, video streams and audio streams may have different QoS requirements and thus can be transmitted as separate QoS flows.

In the radio interface, QoS flows are mapped to DRBs (Data Radio Bearers) for transmission, and a single DRB can carry multiple QoS flows. DRBs are further mapped to Logical Channels, which are identified by LCID (Logical Channel ID) at the MAC (Medium Access Control) layer.

The relationship between these protocol entities can be summarized as follows: Data Network↔PDU Session↔QoS Flow (identified by QFI)↔DRB↔Logical Channel (identified by LCID)↔MAC PDU. This layered structure enables flexible QoS management while maintaining efficiency in the radio interface.

A MAC PDU (MAC Protocol Data Unit) is a data unit delivered from the MAC layer to the physical layer, consisting of one or more MAC subheaders and MAC SDUs (Service Data Units) or MAC CEs (Control Elements). Each MAC subheader contains information to identify the corresponding MAC SDU or MAC CE.

The MAC PDU structure is organized as follows: MAC PDU=[MAC subheader 1][MAC subheader 2] . . . [MAC subheader n][MAC SDU/CE 1][MAC SDU/CE 2] . . . [MAC SDU/CEn][optional padding]. The MAC subheaders appear at the beginning of the MAC PDU, followed by the corresponding payloads.

The main fields of a MAC subheader are as follows. The R (Reserved) field consists of bits reserved for future use. The F (Format) field indicates the size of the length field. The LCID (Logical Channel ID) field identifies the logical channel to which the MAC SDU belongs or identifies the type of MAC CE. The L (Length) field indicates the length of the MAC SDU or MAC CE in bytes.

The MAC PDU format allows flexible multiplexing of data from different logical channels and insertion of MAC control elements for various control functions. The order of MAC subheaders and their corresponding payloads is fixed, with MAC CEs typically appearing before MAC SDUs.

LCID (Logical Channel ID) is an identifier included in the MAC subheader and typically has a size of 6 bits. LCID identifies logical channels with values in the range 0-32, or indicates the type of MAC CE with specific values (e.g., 33-63). For example, certain LCID values are reserved for specific MAC CE types such as Configured Grant Confirmation, Buffer Status Report, or Padding.

However, with the evolution of 5G NR systems and the addition of new features, the 6-bit LCID space became insufficient. To address this problem, the concept of eLCID (extended LCID) was introduced.

eLCID extends the identification space by using a two-octet format. When a specific LCID value is designated to indicate the presence of an eLCID field, the actual identifier is read from the subsequent eLCID field, which provides a much larger identification space. This allows the system to support new MAC CE types and additional logical channels without being constrained by the original 6-bit LCID limitation.

The eLCID mechanism operates as follows: when the LCID field in the MAC subheader contains a predetermined value indicating eLCID presence, the receiver understands that an eLCID field follows in the next octet(s), and the actual identification is obtained from this eLCID field. This hierarchical identification scheme provides backward compatibility while enabling system expansion. The recommended bit rate MAC CE and the extended recommended bit rate MAC CE are distinguished by using LCID and eLCID, respectively.

Logical Channel Prioritization (LCP) is a MAC layer procedure that determines how uplink resources are allocated among different logical channels when the MAC entity has data to transmit. When the UE is granted uplink resources by the gNB, the LCP procedure is invoked to decide which logical channels can utilize these resources and how much data from each logical channel should be included in the MAC PDU.

The LCP procedure considers several parameters configured for each logical channel, including priority, Prioritized Bit Rate (PBR), and Bucket Size Duration (BSD). Logical channels with higher priority and sufficient PBR are served first. After all logical channels have been served up to their PBR, any remaining resources are allocated to logical channels in decreasing order of priority.

In the context of rate control, the LCP procedure determines whether sufficient uplink resources are available to accommodate a Recommended bit rate MAC CE or Extended Recommended bit rate MAC CE plus its subheader. If the allocated UL resources can accommodate the MAC CE as a result of LCP, the MAC entity proceeds to generate and transmit the MAC CE. This ensures that rate control signaling does not unduly consume resources needed for user data transmission.

The present invention provides several advantageous effects. First, by using a CID that simultaneously identifies PDU session and QoS flow, the system enables precise bitrate control at the finest granularity, which is essential for multi-service environments where a single UE runs multiple applications with diverse QoS requirements.

Second, by employing different granularities of bitrate indices in coarse-grained rate control (6-bit with ~13% steps) and fine-grained rate control (7-bit with ~10% steps), the system achieves an optimal balance between control precision and signaling overhead. Services that benefit from fine-grained control (such as XR) can use fine-grained rate control, while services that can tolerate coarser adjustments can use coarse-grained rate control, thereby improving overall system efficiency.

Third, the enhanced rate control mechanism improves the quality of experience for XR services by enabling smooth and responsive bitrate adaptation. This reduces the occurrence of video freezing, quality degradation, and motion sickness, leading to higher user satisfaction.

Fourth, the mechanism improves radio resource utilization by preventing over-allocation (when bitrate is too high) and under-utilization (when bitrate is too low), thereby increasing overall system capacity and allowing more users to be served with acceptable quality.

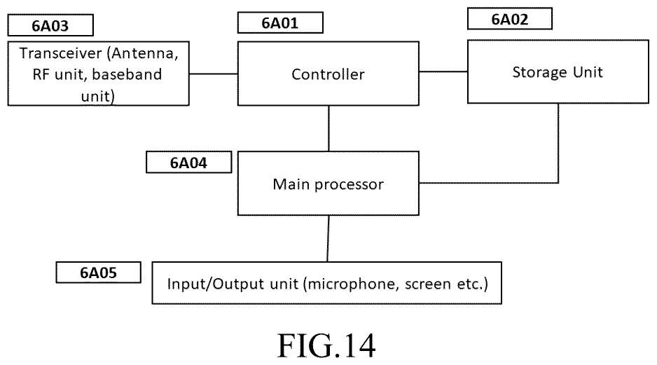

FIG. 14 is a diagram illustrating internal structure of terminal.

Referring to the diagram, the terminal includes a controller (6A01), a storage unit (6A02), a transceiver (6A03), a main processor (6A04) and I/O unit (6A05).

The controller (6A01) controls the overall operations of the terminal in terms of mobile communication. For example, the controller (6A01) receives/transmits signals through the transceiver (6A03). In addition, the controller (6A01) records and reads data in the storage unit (6A02). To this end, the controller (6A01) includes at least one processor. For example, the controller (6A01) may include a communication processor (CP) that performs control for communication and an application processor (AP) that controls the upper layer, such as an application program. The controller controls storage unit and transceiver such that UE operations illustrated in this disclosure are performed.

The storage unit (6A02) stores data for operation of the terminal, such as a basic program, an application program, and configuration information. The storage unit (6A02) provides stored data at a request of the controller (6A01).

The transceiver (6A03) consists of a RF processor, a baseband processor and plurality of antennas. The RF processor performs functions for transmitting/receiving signals through a wireless channel, such as signal band conversion, amplification, and the like. Specifically, the RF processor up-converts a baseband signal provided from the baseband processor into an RF band signal, transmits the same through an antenna, and down-converts an RF band signal received through the antenna into a baseband signal. The RF processor may include a transmission filter, a reception filter, an amplifier, a mi10r, an oscillator, a digital-to-analog converter (DAC), an analog-to-digital converter (ADC), and the like. The RF processor may perform MIMO and may receive multiple layers when performing the MIMO operation. The baseband processor performs a function of conversion between a baseband signal and a bit string according to the physical layer specification of the system. For example, during data transmission, the baseband processor encodes and modulates a transmission bit string, thereby generating complex symbols. In addition, during data reception, the baseband processor demodulates and decodes a baseband signal provided from the RF processor, thereby restoring a reception bit string.

The main processor (6A04) controls the overall operations other than mobile operation. The main processor (6A04) process user input received from I/O unit (6A05), stores data in the storage unit (6A02), controls the controller (6A01) for required mobile communication operations and forward user data to I/O unit (6A05).

I/O unit (6A05) consists of equipment for inputting user data and for outputting user data such as a microphone and a screen. I/O unit (6A05) performs inputting and outputting user data based on the main processor's instruction.

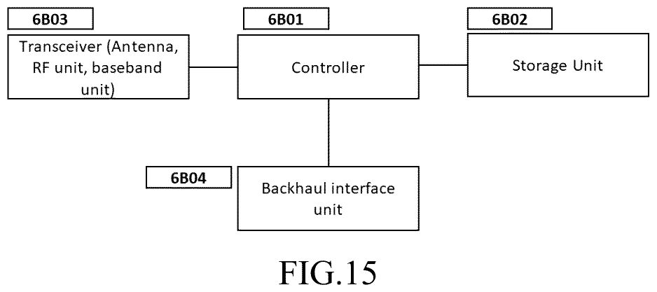

FIG. 15 is a block diagram illustrating the internal structure of a base station according to the disclosure.

As illustrated in the diagram, the base station includes a controller (6B01), a storage unit (6B02), a transceiver (6B03) and a backhaul interface unit (6B04).

The controller (6B01) controls the overall operations of the main base station. For example, the controller (6B01) receives/transmits signals through the transceiver (6B03), or through the backhaul interface unit (6B04). In addition, the controller (6B01) records and reads data in the storage unit (6B02). To this end, the controller (6B01) may include at least one processor. The controller controls transceiver, storage unit and backhaul interface such that base station operation illustrated in this disclosure are performed.

The storage unit (6B02) stores data for operation of the main base station, such as a basic program, an application program, and configuration information. Particularly, the storage unit (6B02) may store information regarding a bearer allocated to an accessed UE, a measurement result reported from the accessed UE, and the like. In addition, the storage unit (6B02) may store information serving as a criterion to deter mine whether to provide the terminal with multi-connection or to discontinue the same. In addition, the storage unit (6B02) provides stored data at a request of the controller (6B01).

The transceiver (6B03) consists of a RF processor, a baseband processor and plurality of antennas. The RF processor performs functions for transmitting/receiving signals through a wireless channel, such as signal band conversion, amplification, and the like. Specifically, the RF processor up-converts a baseband signal provided from the baseband processor into an RF band signal, transmits the same through an antenna, and down-converts an RF band signal received through the antenna into a baseband signal. The RF processor may include a transmission filter, a reception filter, an amplifier, a mi10r, an oscillator, a DAC, an ADC, and the like. The RF processor may perform a down link MIMO operation by transmitting at least one layer. The baseband processor performs a function of conversion between a baseband signal and a bit string according to the physical layer specification of the first radio access technology. For example, during data transmission, the baseband processor encodes and modulates a transmission bit string, thereby generating complex symbols. In addition, during data reception, the baseband processor demodulates and decodes a baseband signal provided from the RF processor, thereby restoring a reception bit string.

The backhaul interface unit (6B04) provides an interface for communicating with other nodes inside the network. The backhaul interface unit (6B04) converts a bit string transmitted from the base station to another node, for example, another base station or a core network, into a physical signal, and converts a physical signal received from the other node into a bit string.

What is claimed is:

1. A method performed by a terminal, the method comprising:
determining a necessity for a bit rate query;
upon availability of an uplink resource for a new transmission, determining whether to generate a Medium Access Control (MAC) Control Element (CE) for the bit rate query based on whether a predetermined timer is running and a result of a Logical Channel Prioritization (LCP) procedure;
generating the MAC CE for the bit rate query based on the determination; and
transmitting the generated MAC CE,
wherein the predetermined timer is:
a prohibit timer configured for a logical channel in case that the bit rate query is for the logical channel; and
a prohibit timer configured for a Quality of Service (QoS) flow in case that the bit rate query is for the QoS flow,
wherein the MAC CE for the bit rate query comprises one of:
information specifying the logical channel when the bit rate query is for the logical channel; and
information jointly specifying the QoS flow and a Protocol Data Unit (PDU) session when the bit rate query is for the QoS flow,
wherein n and m are positive integers where m is greater than n, and
wherein the MAC CE for the bit rate query further comprises:
n-bit bit rate information when the bit rate query is for the logical channel, and
m-bit bit rate information when the bit rate query is for the QoS flow.

2. A method performed by a terminal, the method comprising:
determining a necessity for a bit rate query for a Quality of Service (QoS) flow;
upon availability of an uplink resource for a new transmission, determining to generate a Medium Access Control (MAC) Control Element (CE) for the bit rate query based on a prohibit timer configured for the QoS flow not being running;
generating the MAC CE for the bit rate query based on the determination; and
transmitting the generated MAC CE,
wherein the MAC CE for the bit rate query comprises:
information jointly specifying the QoS flow and a Protocol Data Unit (PDU) session; and
m-bit bit rate information, wherein m is a positive integer greater than n, and n represents a bit-width of bit rate information for a logical channel.

3. The method of claim 2, wherein a MAC subheader of the MAC CE for the bit rate query comprises:
a first field indicating presence of a second field; and
the second field indicating that the bit rate query is for the QoS flow.

4. The method of claim 2, wherein the prohibit timer configured for the QoS flow is:
configured via a Radio Resource Control (RRC) message; and
started in response to bit rate query information for the QoS flow being included in the MAC CE for the bit rate query.

5. The method of claim 2, wherein:
the m-bit bit rate information indicates an index to a bit rate table;
the bit rate table comprises a plurality of predefined bit rate values with non-linear step sizes;
a step size between consecutive indices in the bit rate table is non-decreasing; and
the index represents a desired bit rate for the bit rate query.
